(19) United States
(12) Patent Application Publication
(10) Pub. No.: US 2006/0290165 A1
(43) Pub. Date: Dec. 28, 2006

(54) Gargo rack cover

(76) Inventor: Mike Grudek, Encinitas, CA (US)

Correspondence Address: Mike Grudek, 725 Clark Avenue, Encinitas, CA, 92024, US

(21) Appl. No.: 11/391,516

(22) Filed: Mar. 28, 2006

Related U.S. Application Data
(60) Provisional application No. 60/680,341, filed on May 12, 2005.

(51) Int. Cl. B60J 7/20

(52) U.S. Cl. 296/136.12

(57) ABSTRACT

A cargo rack cover designed for the pick up truck and four post utility cargo rack which extends above the truck bed and cab which is mounted on the walls or bed of the truck which is fabric based, attached under the cargo rack and frame creating a weather resistant shell for the protection of goods in the bed or on the cargo rack.

### CROSS-REFERENCE TO RELATED APPLICATION

This application relies on a previously filed provisional application 60/680,341 filed: May 12, 2005

### STATEMENT REGARDING FEDERALLY SPONSORED RESEARCH OR DEVELOPMENT

Not applicable

### REFERENCE TO SEQUENCE LISTING

Not applicable

### BACKGROUND

The cargo rack was created 30 to 40 years ago. It was created to maximize the hauling capabilities of pick up trucks. Pick up trucks have limits on the length of items that can safely be carried in the bed of the truck. A cargo rack allows the truck to carry long items (cargos, lumber, pipe, etc.) safely above the bed and cab of the truck while allowing the bed of the pick up truck to be free to carry other smaller items.

Pick up truck bed covers have been around in different forms since the pick up truck was created. Truck bed covers have evolved from the simplest tarp laid over the truck bed and contents to truck bed shells which use fiberglass to enclose the bed of the truck. People have created different truck bed covers for individual needs. The function and capabilities of these covers vary from one to the other. Truck bed covers are built for protection from weather, theft, camping, etc. The array of truck bed covers that now exist are classified as the fiberglass/hard shell, fabric convertible shell, hard and soft Tonneau covers, truck bed tents, and camper shells.

1. Prior Art

The cargo cover of the current invention differs from prior inventions relating to truck campers like the Cornelius invention U.S. Pat. No. 6,439,646 or Sidlinger U.S. Pat. No. 4,215,894 as the current invention attaches to a cargo or lumber rack (like James U.S. Pat. No. 5,628,540) which extends over the cab of a pickup truck for the purpose of carrying long and heavy materials such as cargos or lumber, unlike prior art. The cargo cover of the present invention allows for coverage and protection of materials stored within the confines of the truck and cargo rack yet allowing complete exposure to the horizontal upper supports of the cargo rack for the transportation of lengthy, heavy materials.

Furthermore, the Cornelius invention is supported by an inner frame. The current invention is supported or hung from within the outer frame of the cargo rack, allowing complete use of the outer frame for cargo.

The cargo cover of the current invention differs from prior inventions relating to framed covers like Brown U.S. Pat. No. 3,354,891 and Ingram U.S. Pat. No. 5,423,587 as the current invention is not supported by an inner frame and does not lay on or attach to a frame uder its body.

The cargo cover of the current device is an improvement over all existing art as the cargo cover of the existing invention hangs within the frame of the trucks cargo or lumber rack, exposing all horizontal members of the cargo rack for stacking and hanging payloads without damaging the cargo cover. The current invention is designed to protect those payloads inside and under the trucks cargo rack.

### DETAILED DESCRIPTION OF THE INVENTION

The cargo rack cover is designed for the pick up truck that has a cargo rack mounted on the bed of the truck which extends over the cab. The device is a fabric based tarp or cover attached under the cargo rack and bed of the pick up truck, creating a weather resistant shell for the protection of goods in the bed of the pick up.

The materials used in the construction of the cargo rack cover are fabric, webbing, clear vinyl, zippers, snaps, and VELCRO. The fabric attaches around the legs of the cargo rack with zippers (can be attached rope, buttons, snaps, VELCRO, etc,). At the top of the legs the fabric has VELCRO collars which rap around the legs helping to attach the tarp and in creating a weather resistant seal. The base of the tarp attaches to the top of the bed of the truck using snaps (can be rope, buttons, VELCRO, etc.). The top of the tarp is suspended below the top of the cargo rack by VELCRO straps (can be hooks, buckled straps, etc.). The straps wrap around the crossbars, and cables that can be installed in place of missing crossbars, providing further support for the top of the tarp. The tarp has clear vinyl windows in both the front and back. These windows provide both visibility for the driver of the truck, and access as the windows can be unzipped. The sides of the tarp also have panels (can be windows if desired) that unzip to allow access to bed of the truck. For extra support there are cables run inside tarp from one leg of the cargo rack to the other on both sides of the tarp. The roof of the tarp can have tent poles installed to keep the rain and snow from pooling on the top of the tarp.

The cargo rack cover of the invention differs from prior inventions relating to truck bed covers as the cargo rack cover does not maintain or make claim to any solid support system or framing. The cargo rack cover is attached under the cargo rack and truck bead by VELCRO strapping and snaps, protecting materials stored on the rack or in the bed of the truck from the elements

The cargo rack cover of the invention differs from prior inventions relating to truck bed storage racks or cargo racks as the cargo rack cover does not maintain or make claim to any solid framing, rack or material carrying capabilities. The cargo rack cover is a protective cover for materials contained under the related rack.

### ILLLUSTRATIONS

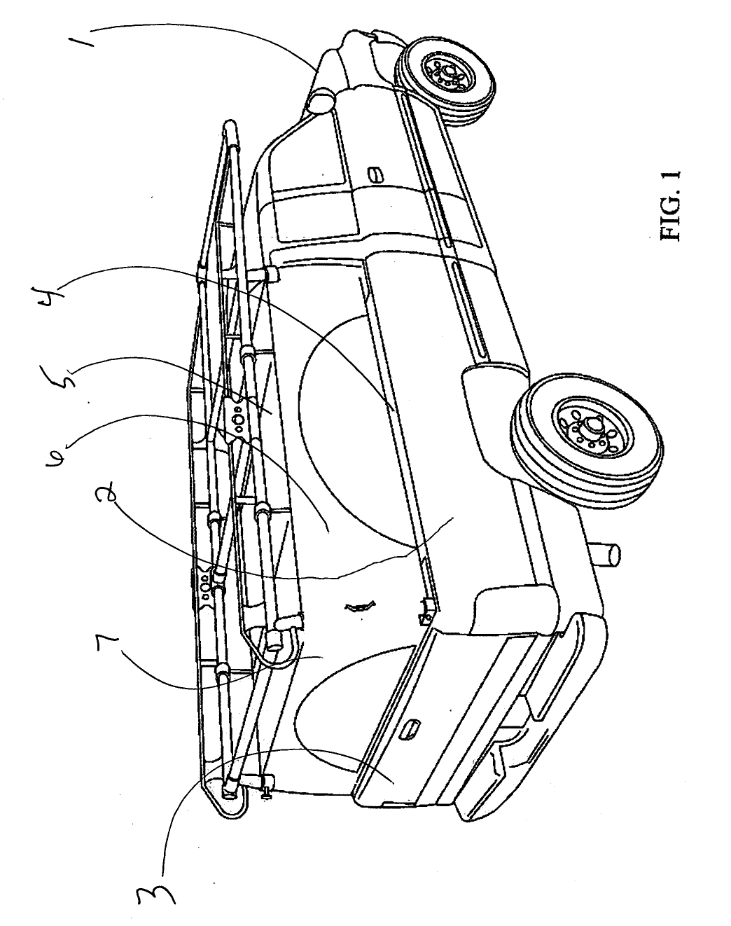

FIG. 1 A perspective view of the rear and right side of the device.

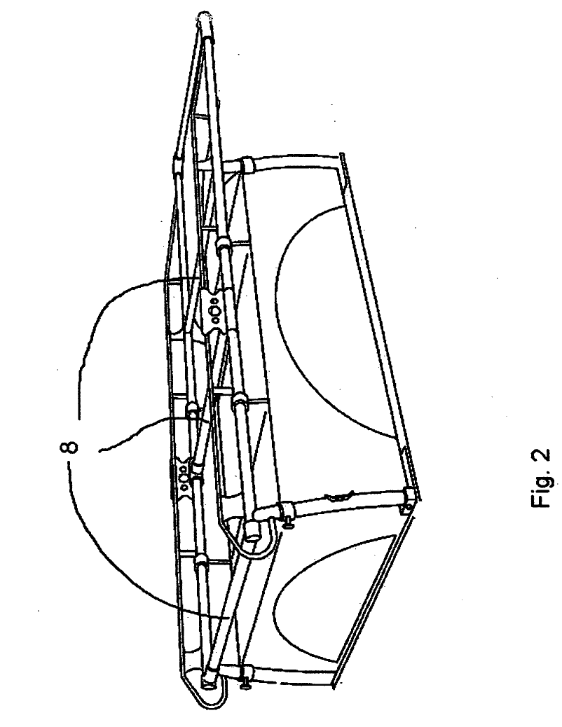

FIG. 2 A perspective view of the right side of the device.

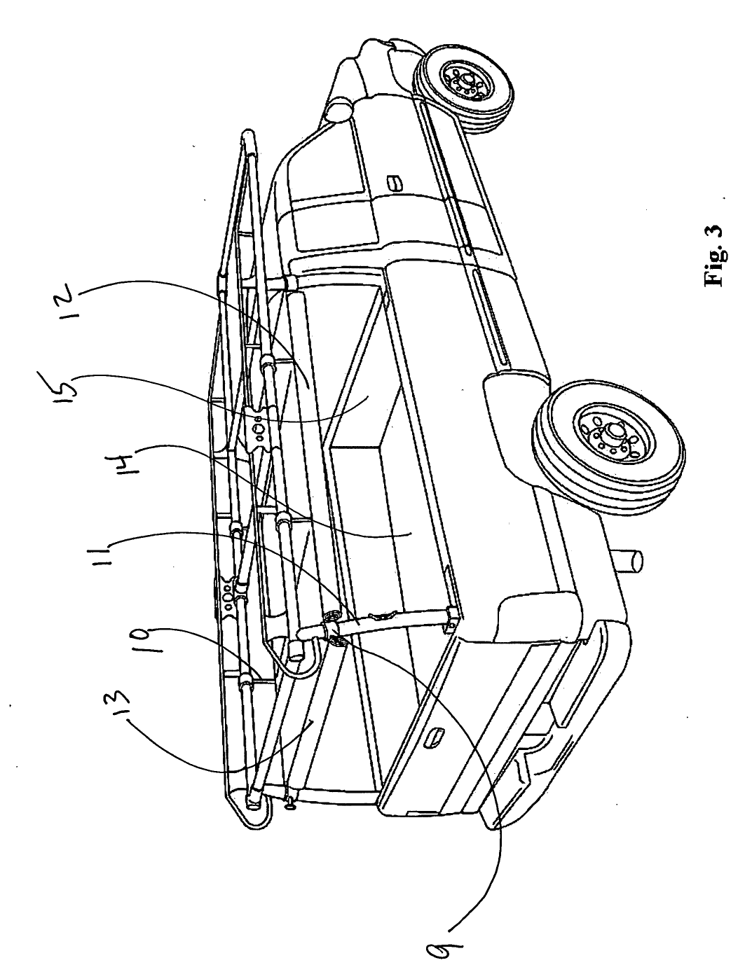

FIG. 3 A perspective view of the right side of the device with all side and rear vinyl windows rolled up to allow access to the bed of the truck from all angles.

### DESCRIPTION OF THE PREFERRED EMBODIMENT

Referring now to FIGS. 1 and 2, the pickup cargo rack cover of the present invention is used in conjunction with a standard pickup truck shown generally at numeral 1 for protecting cargo therein from weather and other external elements. The pickup truck usually has an open bed having upwardly projecting parallel sidewalls 2, a rear wall 3 which usually has a tailgate and an upwardly projecting front wall. Each side wall 2 has a substantially planar upper surface 4.

Referring now to FIG. 3, numerals 12 and 13 depict the device as it is rolled up and stored as to access the contents of the truck. Numeral 11 illustrates the upright members of the cargo rack mounted above the side walls of the truck. The truck bed is defined by numerals 14, the front wall of the truck bed and numeral 15, the rear wall of the truck bed.

The device comprises a cover 5 preferably made with nylon, canvas or a similar durable weather resistant material. The cover 5 has a substantially rectangular configuration forming a box type enclosure when placed over the frame members having a pair of side walls 6, and a rear panel 7. Securing the cover member 5 to the cargo frame 8 members are VELCRO straps 9 and cables 10.

The cover side and rear panels 11 has a substantially transparent window having four peripheral edges made from a shatter resistant material such as plastic or clear vinyl. Surrounding and substantially parallel to three of the peripheral edges of the window 11 is an access zipper 12 for selectively enclosing the cover and providing an access to the interior thereof.

We claim:

1. A cargo rack cover for mounting under a pickup truck cargo rack comprising:
an all weather cover adapted to attach to, and securely fit under, a cargo rack frame which extends over a truck bed and cab, the cover including a plurality of panels, wherein each panel has a first closed position which seals the cargo rack cover to a second open position which allows access through the cover front and sides to the interior of the truck bed; and
attachment straps on the upper, outside roof panel to support the roof of the cargo rack cover and attachment straps for the vertical support rails on each corner of the cargo rack.

2. A cargo rack cover according to claim 1, wherein clear vinyl windows are affixed to both sides and rear of the device.

3. A cargo rack cover, according to claim 1, wherein the cargo rack cover maintains straps to affix the rear, left and right sides to the upper horizontal supports of the cargo rack.

4. A cargo rack cover, according to claim 1, wherein the sides or back of the cover can be temporarily affixed in an upward or open position to allow easy access to materials within the truck or on the cargo rack.

5. A cargo rack cover to be temporarily connected to a pick up truck and cargo rack having an open bed with front and rear walls for the purpose of creating a weather resistant shell for the protection of goods in the bed or on the cargo rack.

7. A cargo rack cover, according to claim 1, wherein the cargo rack cover can be rolled up and stored on the cargo rack when not in use.
